(19) United States
(12) Patent Application Publication
(10) Pub. No.: US 2014/0233653 A1
(43) Pub. Date: Aug. 21, 2014

(54) DECODER AND ENCODER FOR PICTURE OUTPUTTING AND METHODS THEREOF

(71) Applicant: Telefonaktiebolaget L M Ericsson (publ), Stockholm (SE)

(72) Inventors: Jonatan Samuelsson, Stockholm (SE); Rickard Sjöberg, Stockholm (SE); Per Wennersten, Arsta (SE)

(73) Assignee: Telefonaktiebolaget L M Ericsson (publ), Stockholm (SE)

(21) Appl. No.: 14/346,418

(22) PCT Filed: Sep. 26, 2012
(86) PCT No.: PCT/SE2012/051018

§ 371 Date: Mar. 21, 2014

Related U.S. Application Data
(60) Provisional application No. 61/541,242, filed on Sep. 30, 2011.

(51) Int. Cl. H04N 19/51; H04N 19/44

(52) U.S. Cl. CPC H04N 19/00696; H04N 19/00533
USPC 375/240.16; 375/240.25

(57) ABSTRACT

An object of the embodiments of the present invention is to achieve a robust solution for keeping track of the output order. That is achieved by introducing a set of Allowed POC Values (APV) which is signaled from the encoder to the decoder. In this way the number of allowed POC values will be limited, and in this way there is no risk that the output order is undefined if occasional pictures are lost.

### TECHNICAL FIELD

The present embodiments generally relate to video encoding and decoding, and in particular to a process of outputting pictures.

### BACKGROUND

H.264 (MPEG-4 AVC) is the state of the art video coding standard. It consists of a block based hybrid video coding scheme that exploits temporal and spatial prediction. The process for outputting and displaying pictures is invoked after the decoding of a picture and after the marking of pictures as “unused for reference”, “used for short-term reference” and “used for long-term reference” as illustrated in the simplified flow chart for the decoding steps in FIG. 1.

It should be noted that the “bumping process” refers to a process that ensures that pictures are outputted in the correct order, as late as possible, limited by the size of the picture buffer and the number of reference frames, to allow for picture reordering.

High Efficiency Video Coding (HEVC) is a new video coding standard currently being developed in Joint Collaborative Team—Video Coding (JCT-VC). JCT-VC is a collaborative project between Moving Picture Experts Group (MPEG) and International Telecommunication Union—Telecommunication Standardization Sector (ITU-T). Currently, an HEVC Model (BM) is defined that includes a number of new tools and is considerably more efficient than H.264/Advanced Video Coding (AVC).

A picture in HEVC is partitioned into one or more slices, where each slice is an independently decodable segment of the picture. This means that if a slice is missing, for instance got lost during transmission, the other slices of that picture can still be decoded correctly. In order to make slices independent, they do not depend on each other. No bitstream element of another slice of the same picture is required for decoding any element of a particular slice.

Each slice contains a slice header which independently provides all required data for the slice to be independently decodable. One example of a data element present in the slice header is the slice address, which is used for the decoder to know the spatial location of the slice. Another example is the slice quantization delta which is used by the decoder to know what quantization parameter to use for the start of the slice. However, these are only examples of data elements in the slice header.

HEVC also has mechanisms for handling reference pictures which are previously decoded pictures to be used for decoding of a current picture. The pictures to be used as reference pictures are included in reference picture lists, which for HEVC is similar to the reference picture list in H.264. The reference picture lists are then used in the decoding process of the current slice in the current picture.

HEVC also defines a temporal_id for each picture, corresponding to the temporal layer that the picture belongs to. Temporal layers are ordered and are used for temporal scalability where higher temporal layers can be removed without affecting the decoding of lower temporal layers. That means that if temporal layer A is higher than temporal layer B, a picture belonging to temporal layer A can use a picture from temporal layer B for prediction but a picture belonging to temporal layer B can not use a picture from temporal layer A for prediction.

HEVC uses absolute signaling of reference pictures instead of signaling reference picture modifications in a relative way as in previous standards, e.g. H.264. The absolute signaling is realized by signaling what reference pictures to keep to the decoder in a Buffer Description (or Reference Picture Set, RPS), for each picture explicitly or by using a reference to a Sequence Parameter Set (SPS) which shows which pictures to be used as reference pictures. Picture Order Count (POC) is used in HEVC to define the output order (display order) of pictures and also to identify reference pictures. The POC is signaled for each reference picture in the Buffer Description. The values of POC in the Buffer Description must be identical to the values of POC signaled in the slice header of the reference picture to which it is referring.

temporal_id is used during picture marking process in order to deduce if a picture has been unintentionally lost or correctly removed. It can be noted that the process of deducing if a picture has been unintentionally lost or correctly removed is independent of the actual picture marking process and could be performed before or after the picture marking.

Temporal_id is also used during reference picture list construction process. Reference pictures that belongs to higher temporal layers than the temporal layer of the current picture are not included in reference picture lists.

In HEVC, the output process is changed so that marking of pictures as “unused for prediction” is performed prior to decoding of the current picture. The output process is also performed prior to the decoding of the current picture. This is illustrated in FIG. 2.

Picture order count (POC) is calculated for each picture in the decoder as a sum of the syntax element pic_order_cnt lsb and the variable PicOrderCntMsb which is calculated based on the value of POC for a previous reference picture decoding order.
PicOrderCntMsb is derived as specified by the following pseudo-code:

| | |
|---|---|
| if( ( pic_order_cnt_lsb < prevPicOrderCntLsb ) && | |
| ( ( prevPicOrderCntLsb − pic_order_cnt_lsb ) >= ( MaxPicOrderCntLsb / 2 ) ) ) | |
| PicOrderCntMsb = prevPicOrderCntMsb + MaxPicOrderCntLsb | (8-1) |
| else if( (pic_order_cnt_lsb > prevPicOrderCntLsb ) && | |
| ( (pic_order_cnt_lsb − prevPicOrderCntLsb ) > ( MaxPicOrderCntLsb / 2 ) ) ) | |
| PicOrderCntMsb = prevPicOrderCntMsb − MaxPicOrderCntLsb | |
| else | |
| PicOrderCntMsb = prevPicOrderCntMsb | |

where prevPicOrderCntMsb and prevPicOrderCntLsb comes from a previous reference picture in decoding order.

If that previous reference picture is lost for example due to packet losses in the transmission, there is a risk that PicOrderCntMsb will be given the wrong value in the decoding process and thus giving the picture incorrect POC value. This might result in an incorrect output order of the decoded pictures.

The problem with the existing solution is depicted in FIG. 3.

Assume that picture A is the first picture in the bitstream and picture B and C is the second and third picture in the bitstream respectively. Assume further that the POC lsb for A is 0, POC lsb for B is MaxPOC/3 and POC lsb for C is 2/3*MaxPOC. If the decoder receives A and then C due to that B has been lost. C will be given a lower POC value than A which is incorrect.

### SUMMARY

An object of the embodiments of the present invention is to achieve a robust solution for keeping track of the output order.

That is achieved by introducing a set of Allowed POC Values (APV) which is signaled from the encoder to the decoder. In this way the number of allowed POC values will be limited, and in this way there is no risk that the output order is undefined if occasional pictures are lost.

According to a first aspect of the embodiments of the present invention a method of decoding an encoded representation of a current picture of a video stream of multiple pictures using reference pictures is provided. A Picture Order Count (POC) value is assigned indicating an order in which the current pictures should be output. In the method, a set of Allowed POC values (APVs) comprising a number of allowed POC values is received. Pictures are outputted from the decoded picture buffer which are marked as “needed for output” if the POC values of said pictures are not included in the set of APVs, and said pictures are marked as “not needed for output”.

According to a second aspect a method of encoding a representation of a current picture of a video stream of multiple pictures using reference pictures is provided. A Picture Order Count (POC) value is assigned indicating to a decoder an order in which the current pictures should be output. In the method a set of Allowed POC values (APVs) comprising a number of allowed POC values is assigned, and the set of APVs is sent to the decoder.

According to a third aspect a decoder for decoding an encoded representation of a current picture of a video stream of multiple pictures using reference pictures is provided. A POC value is assigned indicating an order in which the current pictures should be output and the decoder is configured to decode a set of APVs comprising a number of allowed POC values. Furthermore, the decoder comprises a processor configured to output pictures from the decoded picture buffer which are marked as “needed for output” if the POC values of said pictures are not included in the set of APVs and to mark, said pictures as “not needed for output”.

According to a fourth aspect, an encoder for encoding a representation of a current picture of a video stream of multiple pictures using reference pictures is provided. A POC value is assigned indicating to a decoder an order in which the current pictures should be output. The encoder comprises a processor configured to assign a set of APVs comprising a number of allowed POC values, and the encoder is configured to encode the set of APVs.

### BRIEF DESCRIPTION OF THE DRAWINGS

FIG. 1 illustrates a simplified decoding flow chart of H.264/AVC according to prior art.

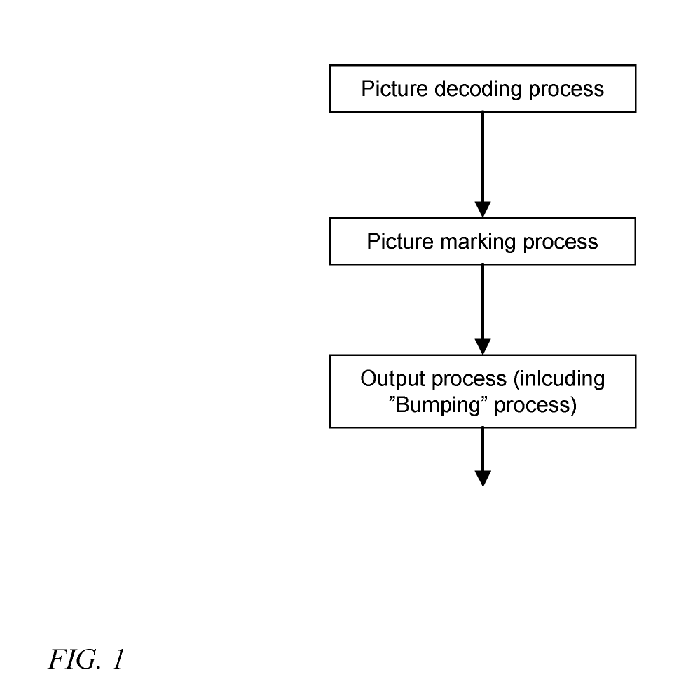

FIG. 2 illustrates a simplified decoding flow chart of HEVC according to prior art.

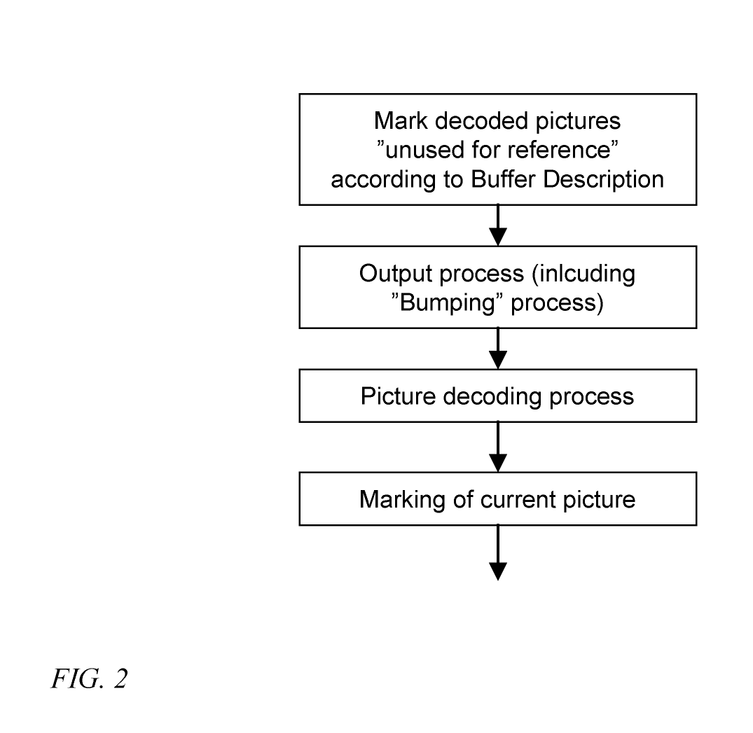

FIG. 3 illustrates a problem with the POC values wrap around in prior art solutions.

FIG. 4 illustrates flowcharts of methods performed by an encoder and a decoder according to embodiments of the present invention.

FIG. 5 illustrates flowcharts of methods performed by an encoder and a decoder according to embodiments of the present invention.

FIG. 6 illustrates schematically a decoder according to embodiments of the present invention.

FIG. 7 illustrates schematically an encoder according to embodiments of the present invention.

### DETAILED DESCRIPTION

In order to avoid the problem of undefined output order, a set of Allowed POC Values (APV) is introduced which consists of a number of integers e.g. in the range from 0 to MaxPOC-1. A rule is introduced that, e.g. at a specific time instant, as described by e.g. the HEVC specification, marks all pictures in the display buffer exemplified by the DPB (decoded picture buffer) as “needed for output” with POC values not in the APV set that shall be output as “not needed for output”. That implies that an encoder assigns a set of APVs, comprising a number of allowed POC values, and sends the set of APVs to the decoder. By means of the APVs the decoder is configured to mark, e.g. at a specific time instant, pictures in a decoded picture buffer which already are marked as “needed for output” as “not needed for output” and output them, if the POC values of the pictures already marked as “needed for output” are not included in the set of APVs.

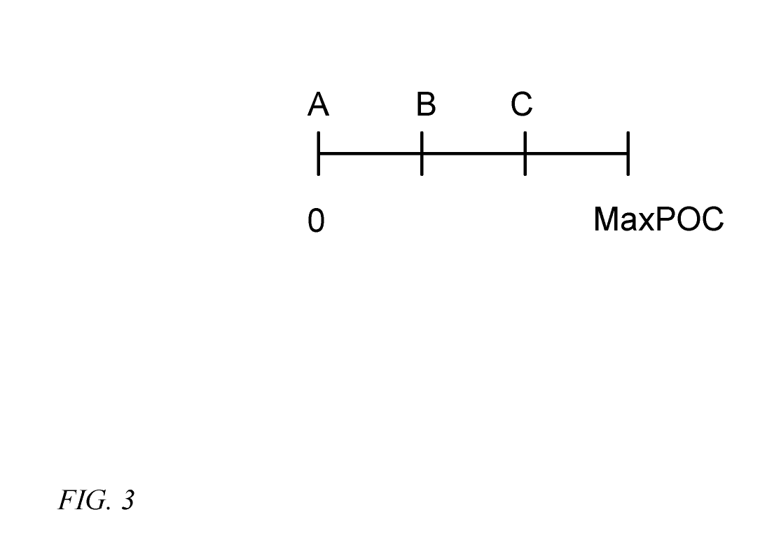

In order to solve the problem that the POC order is undefined, the size of the APV range is restricted such that the output order always can be deduced. With reference to FIG. 3 it could be that the APV set requires A to be output when C is received, thus not all three of them (A, B and C) can be in the DPB marked as “needed for output”.

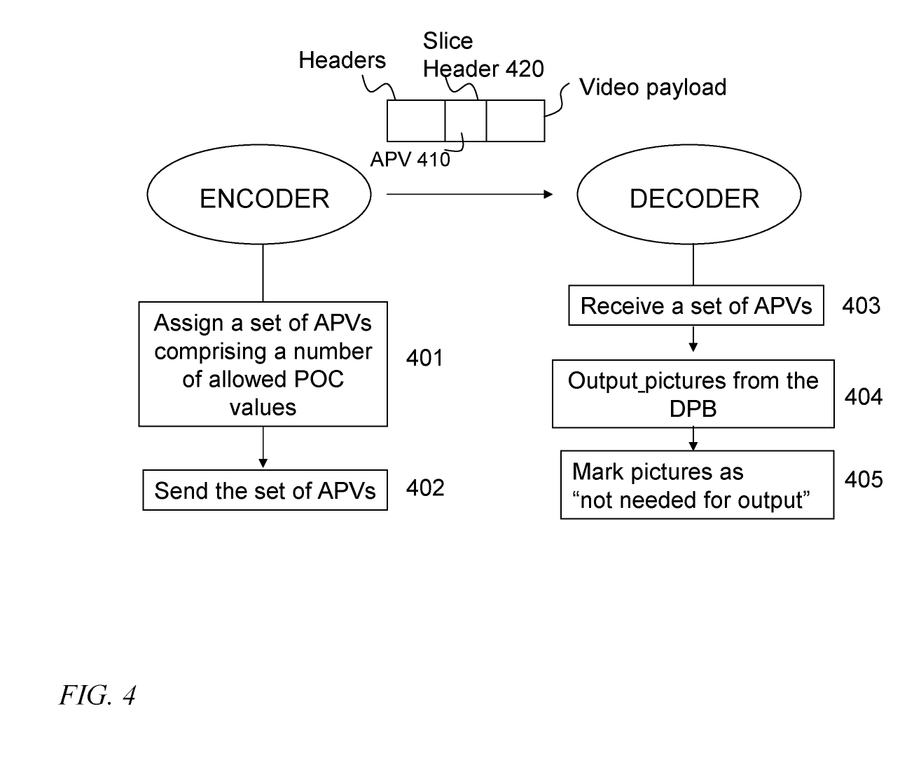

According to a flowchart as illustrated in FIG. 4, a method of encoding a representation of a current picture of a video stream of multiple pictures using reference pictures, wherein the POC value is assigned indicating to a decoder an order in which the current pictures should be output is provided. In the method, set of Allowed POC values, APVs, comprising a number of allowed POC values is assigned 401, and the set of APVs is sent 402 to the decoder.

According to another flowchart as illustrated in FIG. 4, a method of decoding an encoded representation of a current picture of a video stream of multiple pictures using reference pictures wherein a Picture Order Count (POC) value is assigned indicating an order in which the current pictures should be output is provided. In the method, a set of Allowed POC values (APVs) comprising a number of allowed POC values is received 401 and decoded in e.g. the slice header or in a parameter set. Pictures from the decoded picture buffer which are marked as “needed for output” are outputted 404 if the POC values of said pictures are not included in the set of APVs, and said pictures are marked 405 as “not needed for output”. It should be noted that output typically means display but it can also relate to other cases. E.g., a file to file decoding output, can be writing uncompressed video to a new file on a hard drive.

Hence if the set of POC values in the APV set is limited enough, there is no risk that the output order is undefined if occasional pictures are lost. Moreover, the system will be more robust if the set of POC values in the APV set (also referred to set of APVs) is more limited. However, in order to achieve an acceptable robustness, it is desired that all pictures in the DPB which are not yet output are within the range of MaxPOC/2.

According to an embodiment, the POC values in the APV set are indicated in a parameter MaxOutputDelay (represented by an integer). Hence, the decoder receives the parameter MaxOutputDelay indicating the range of POC values of the APV set from the encoder. As an example, the parameter MaxOutputDelay is received in the bitstream in one of Sequence parameter set (SPS), Picture Parameter Set (PPS), Adaptation Parameter Set, APS or a slice header. The active SPS contains information that is valid for the entire coded video sequence. The active PPS contains information that is valid for all slices of the current picture. The POC values included in the APV set may be integers which can be calculated in the encoder and the decoder for each picture using the POC of the current picture and the MaxOutputDelay parameter. Examples how the POC of the current picture and the MaxOutputDelay parameter can be used for calculating the integers to be included in the APV set are shown below:

In one example, the MaxOutputDelay is limited to be in the range from 0 to MaxPOC/4-1 and the integers included in the APV set are calculated for each picture using the POC of the current picture and the MaxOutputDelay variable according to the following: All values higher than or equal to currentPOC-MaxOutputDelay are included in the APV set.

In one embodiment each picture X with a DiffPOC(X, (currentPOC-MaxOutputDelay)%MaxPOC)<0 is displayed and marked as “not needed for output” in the output process performed by the decoder prior to the decoding of the current frame. Hence if a picture in the DPB has a POC value that is lower than (the POC value of the current picture-MaxOutput Delay)%MaxPOC it should be output.

Moreover, according to an alternative the time instant for constructing the APV set and displaying all pictures not in the APV set is selected as the time of the Output Process of a current picture. This is an alternative to the description above (in which pictures are output before decoding of the current picture). In this version the time instant is the same as the output time of the current picture which has to be after the current picture has been decoded

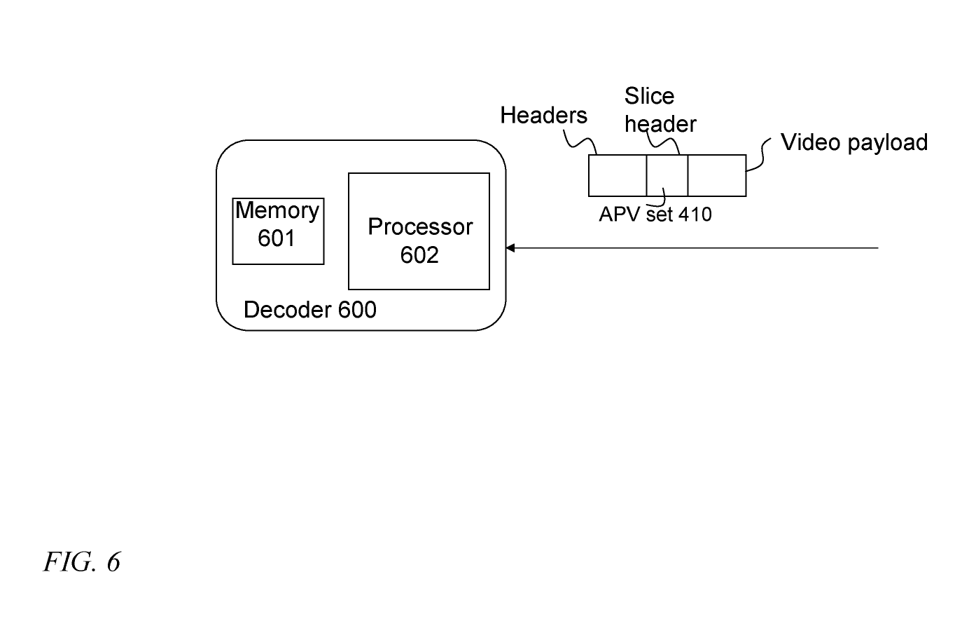

FIG. 6 is a schematic diagram showing some components of the decoder 600. The decoder 600 comprises a processor 602. The processor 602 could be any combination of one or more of a suitable central processing unit (CPU), multiprocessor, microcontroller, digital signal processor (DSP), application specific integrated circuit (ASIC) etc., capable of executing software instructions contained in a computer program stored in one or more memories 601. As illustrated in FIG. 6, a decoder 600 for decoding an encoded representation of a current picture of a video stream of multiple pictures using reference pictures is provided. A POC value is assigned indicating an order in which the current pictures should be output. The decoder is configured to receive and decode a set of APVs 410 comprising a number of allowed POC values. The decoder 600 comprises a processor 602 configured to output pictures from the decoded picture buffer which are marked as “needed for output” if the POC values of said pictures are not included in the set of APVs and to mark, said pictures as “not needed for output”.

According to an embodiment, the decoder is configured to decode a parameter MaxOutputDelay indicating the range of POC values of the APV set. The decoder may also be configured to decode the parameter MaxOutputDelay in the bitstream in one of Sequence parameter set (SPS), Picture Parameter Set (PPS), Adaptation Parameter Set (APS) or a slice header.

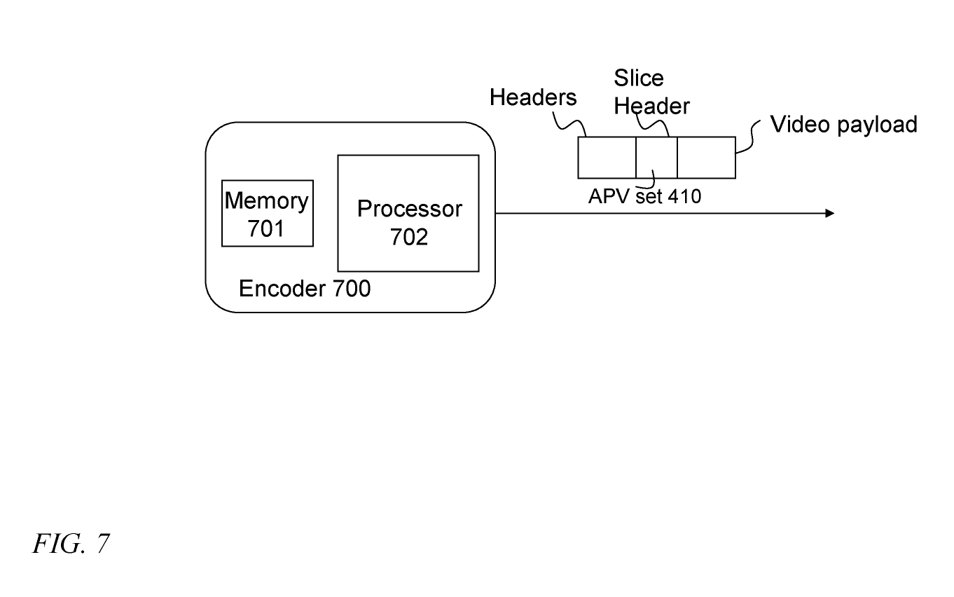

FIG. 7 is a schematic diagram showing some components of the encoder 700. The encoder 700 comprises a processor 702. The processor 702 could be any combination of one or more of a suitable central processing unit (CPU), multiprocessor, microcontroller, digital signal processor (DSP), application specific integrated circuit (ASIC) etc., capable of executing software instructions contained in a computer program stored in one or more memories 701.

As illustrated in FIG. 7 an encoder 700 for encoding a representation of a current picture of a video stream of multiple pictures using reference pictures is provided. A POC value is assigned indicating to a decoder 600 an order in which the current pictures should be output. The encoder 700 comprises a processor 702 configured to assign a set of APVs 410 comprising a number of allowed POC values, and the encoder is configured to encode and send the set of APVs.

According to an embodiment the encoder is configured to encode a parameter MaxOutputDelay indicating the range of POC values of the APV set. The encoder may be further configured to encode the parameter MaxOutputDelay in the bitstream in one of Sequence parameter set (SPS), Picture Parameter Set (PPS), Adaptation Parameter Set (APS) or a slice header.

According to one embodiment, it is signaled in the bitstream when to flush a display buffer (i.e. empty the display buffer by outputting all pictures). This embodiment is independent of the embodiments relating to the APVs. The display buffer can be a DPB, but it could also be a separate buffer used for display but not for reference pictures. It should be noted that in the embodiments, all pictures marked as “needed for output” are being output and marked as “not needed for output”, however they can still be kept in the DPB so that they can be used for reference. In that sense the DPB is not flushed.

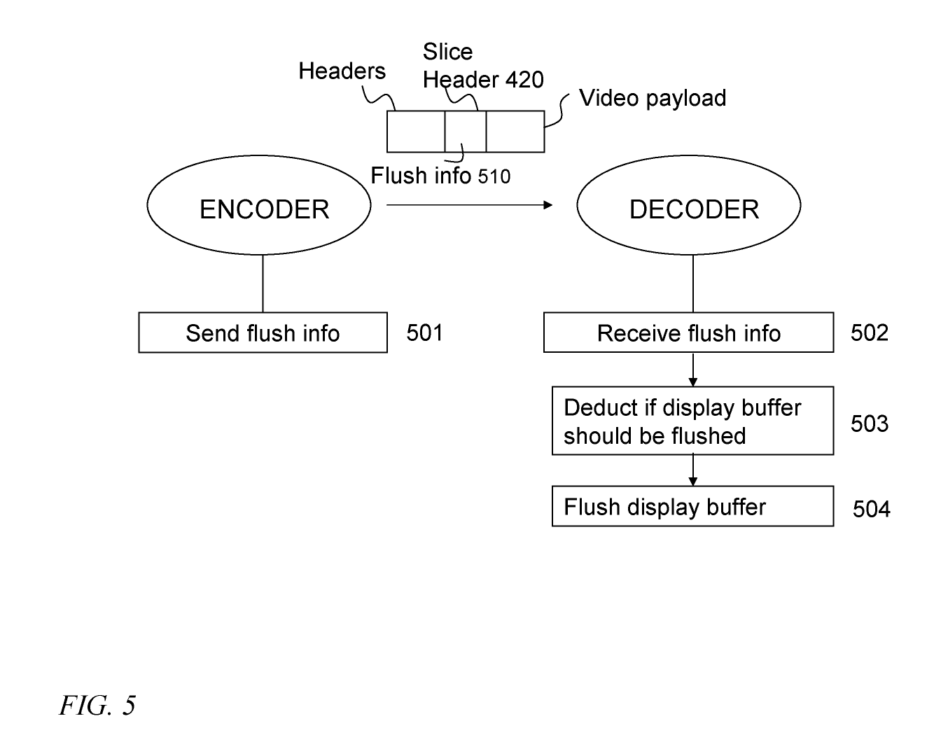

As illustrated in the flowcharts of FIG. 5, the encoder sends (signals) 501 information that the display buffer should be flushed to the decoder, which receives 502 the information accordingly. The decoder deducts 503 whether the display buffer should be flushed based on the received information and then flushes 504 the display buffer if it should be flushed.

The signaled information indicates that all pictures that preceded the current picture in decoding order, precedes, in display order, the current picture and all pictures succeeding in decoding order should be flushed.

That is, there is a way to signal for a current picture A that “All pictures that preceded A in decoding order precedes, in display order, A and all pictures preceding A in decoding order” should be flushed. In other words “A and all pictures that succeeds A in decoding order succeeds all pictures B in display order if B precedes A in decoding order”.

Information when to flush the display buffer is signaled in the slice header of each picture according to one embodiment. In addition, the information when to flush the display buffer may also be signaled in the NAL (Network Abstraction Layer) unit header or tied to a specific NAL unit type or picture type.

According to a further alternative, only pictures with temporal_id equal to 0 are allowed to flush the display buffer.

Further, the signaling of information when to flush the display buffer does not have to be explicit. Instead it can be calculated from other syntax elements and variables such as picture type, POC, temporal_id etc.

Thus, a decoder according to embodiments is configured to receive information when to flush the display buffer. This information can either be explicit signaled or implicit deducted. The decoder displays or outputs all pictures in the DPB marked as “needed for output” in a defined order and marks them as “not needed for output”.

The current picture is decoded and marked according to its OutputFlag.

Accordingly, an encoder according to embodiments is configured to send information when to flush the display buffer by explicit signaling. The encoder is configured to encode the signal comprising the information that the display buffer shall be flushed. The signal comprises e.g. information to the decoder that the display buffer should be flushed for a picture A only if it fulfills the requirement that “All pictures that preceded A in decoding order precedes, in display order, A and all pictures succeeding A in decoding order”. The picture is then encoded.

If implicit signaling is used, the encoder may be configured to deduct whether a flush of the display buffer should be done by ensuring that the bitstream fulfills the requirement that “All pictures that preceded A in decoding order precedes, in display order, A and all pictures succeeding A in decoding order”. The processor of the decoder is then configured to deduct from the received bitstream that the display buffer should be flushed.

According to further embodiments, a restriction regarding the distance in the POC is introduced in order to improve error robustness. In one embodiment, the distance in POC is not allowed to exceed MaxPOC/2 compared to a closest picture in a same or a lower temporal layer. This prevents that old pictures remain in the DPB, where the old pictures have higher POC lsb than the current picture. If those old picture remain in the DPB, one may think that those old pictures should be output later if one or more pictures are lost.

According to another embodiment, the distance in POC is not allowed to exceed >MaxPOC/2 compared to any picture marked as “needed for output” in the DPB.

According to a further alternative, the distance in POC is not allowed to be >MaxPOC/2 compared to any picture marked as “needed for output” in the DPB regardless of how many temporal layers have been decoded.

The encoder is responsible for controlling the above described restrictions and the decoder can use the knowledge of the restriction to discover if something is wrong in the bitstream i.e. due to packet losses.

This embodiment can be combined with the embodiments relating to the flush procedure and to the embodiments relating to the APVs.

In HEVC each picture is associated with a temporal_id. It is desired that the removal of pictures of a higher temporal layer does not affect the output order of pictures in lower temporal layers.

This can be solved by introducing a rule used by the decoder and encoder that:

If there is a picture B with temporal_id(B) such that there is another picture A preceding B in decoding order with temporal_id(A) where temporal_id(A)<=temporal_id(B) DiffPOC(B,A)<0 then there must not be any picture C succeeding A in decoding order and preceding B in decoding order with temporal_id(C) such that temporal_id(C)>temporal_id(B) and for which DiffPOC(C,A)>MaxOutputDelay unless DiffPOC(B,A)>MaxOutputDelay.

DiffPOC is the difference in POC value of two pictures with wrap around taken into account, which is described above.

According to a yet further alternative, the decoder holds a state consisting of an integer that corresponds to a POC value. Whenever a picture that is to be decoded has a lower POC value than the state of the decoder, all pictures in the DPB are outputted and marked “not needed for output”.

1. A method of decoding an encoded representation of a current picture of a video stream of multiple pictures using reference pictures, wherein a Picture Order Count, POC, value is assigned indicating an order in which the current pictures should be output, the method comprising the steps of:
receiving a set of Allowed POC values, APVs, comprising a number of allowed POC values,
outputting pictures from the decoded picture buffer which are marked as “needed for output” if the POC values of said pictures are not included in the set of APVs, and
marking, said pictures as “not needed for output”.

2. The method according to claim 1, wherein the method further comprises:
receiving a parameter MaxOutputDelay indicating the range of POC values of the set of APVs.

3. The method according to claim 2, wherein the parameter MaxOutputDelay is received in the bitstream in one of Sequence parameter set, SPS, Picture Parameter Set, PPS, Adaptation Parameter Set, APS or a slice header.

4. The method according to claim 1, comprising the further step of:
receiving information that a display buffer should be flushed.

5. The method according to claim 4, wherein the received information indicates that all pictures that preceded the current picture in decoding order precedes, in display order, the current picture and all pictures preceding the current picture in decoding order should be flushed.

6. The method according to claim 4, wherein the received information is signaled in a slice header of the current picture.

7. The method according to claim 4, wherein the received information is signaled in a Network Abstraction Layer unit header or tied to a specific NAL unit type or picture type that the display buffer should be flushed.

8. A method of encoding a representation of a current picture of a video stream of multiple pictures using reference pictures, wherein a Picture Order Count, POC, value is assigned indicating to a decoder an order in which the current pictures should be output, the method comprising the steps of:
assigning a set of Allowed POC values, APVs, comprising a number of allowed POC values, and
sending the set of APVs to the decoder.

9. The method according to claim 8, wherein the method further comprises:
sending a parameter MaxOutputDelay indicating the range of POC values of the set of the APVs.

10. The method according to claim 9, wherein the parameter MaxOutputDelay is signaled in the bitstream in one of Sequence parameter set, SPS, Picture Parameter Set, PPS, Adaptation Parameter Set, APS or a slice header.

11. The method according to claim 8, comprising the further step of:
sending information that a display buffer should be flushed.

12. The method according to claim 11, wherein the sent information indicates that all pictures that preceded the current picture in decoding order precedes, in display order, the current picture and all pictures preceding the current picture in decoding order should be flushed.

13. The method according to claim 11, wherein the sent information is signaled in a slice header of the current picture.

14. The method according to claim 11, wherein the sent information is signaled in a Network Abstraction Layer unit header or tied to a specific NAL unit type or picture type that the display buffer should be flushed.

15. The method according to claim 8, wherein the distance in POC to a closest picture in a same or a lower temporal layer is not allowed to exceed MaxPOC/2.

16. The method according to claim 8, wherein the distance in POC to any picture marked as “needed for output” in the DPB is not allowed to exceed >MaxPOC/2.

17. A decoder that decodes an encoded representation of a current picture of a video stream of multiple pictures using reference pictures, wherein a Picture Order Count, POC, value is assigned indicating an order in which the current pictures should be output, the decoder is configured to decode a set of Allowed POC values, APVs, comprising a number of allowed POC values, the decoder comprises a processor configured to output pictures from the decoded picture buffer which are marked as “needed for output” if the POC values of said pictures are not included in the set of APVs and to mark, said pictures as “not needed for output”.

18. The decoder according to claim 17, wherein the decoder is configured to decode a parameter MaxOutputDelay indicating the range of POC values of the set of the APVs.

19. The decoder according to claim 18, wherein decoder is configured to decode the parameter MaxOutputDelay in the bitstream in one of Sequence parameter set, SPS, Picture Parameter Set, PPS, Adaptation Parameter Set, APS or a slice header.

20. The decoder according to claim 17, wherein the decoder is further configured to decode information that a display buffer should be flushed.

21. The decoder according to claim 20, wherein the decoder is further configured to decode information indicating that all pictures that preceded the current picture in decoding order precedes, in display order, the current picture and all pictures preceding the current picture in decoding order should be flushed.

22. The decoder according to claim 22, wherein the decoder is further configured to decode the received information in a slice header of the current picture.

23. The decoder according to claim 20, wherein the decoded information is signaled in a Network Abstraction Layer unit header or tied to a specific NAL unit type or picture type that the display buffer should be flushed.

24. An encoder that encodes a representation of a current picture of a video stream of multiple pictures using reference pictures, wherein a Picture Order Count, POC, value is assigned indicating to a decoder an order in which the current pictures should be output, the encoder comprises a processor configured to assign a set of Allowed POC values, APVs, comprising a number of allowed POC values, and the encoder is configured to encode the set of APVs.

25. The encoder according to claim 24, wherein the encoder is configured to encode a parameter MaxOutputDelay indicating the range of POC values of the set of the APVs.

26. The encoder according to claim 25, wherein the encoder is configured to encode the parameter MaxOutputDelay in the bitstream in one of Sequence parameter set, SPS, Picture Parameter Set, PPS, Adaptation Parameter Set, APS or a slice header.

27. The encoder according to claim 24, wherein the encoder is configured to encode information that a display buffer should be flushed.

28. The encoder according to claim 27, wherein the encoded information indicates that all pictures that preceded the current picture in decoding order precedes, in display order, the current picture and all pictures preceding the current picture in decoding order should be flushed.

29. The encoder according to claim 27, wherein the encoded information is signaled in a slice header of the current picture.

30. The encoder according to claim 27, wherein the encoded information is signaled in a Network Abstraction Layer unit header or tied to a specific NAL unit type or picture type that the display buffer should be flushed.

31. The encoder according to claim 24, wherein the processor is configured to control that the distance in POC to a closest picture in a same or a lower temporal layer is not allowed to exceed MaxPOC/2.

32. The encoder according to claim 24, wherein the processor is configured to control that the distance in POC to any picture marked as “needed for output” in the DPB is not allowed to exceed >MaxPOC/2.
